(19) United States
(12) Patent Application Publication
(10) Pub. No.: US 2006/0116063 A1
(43) Pub. Date: Jun. 1, 2006

(54) Outlet device for the interior of a vehicle

(75) Inventors: Joerg Seume, Hohne (DE); Tom Steglich, Hannover (DE); Stefan Thomassin, Lippstadt (DE)

Correspondence Address: BIRCH STEWART KOLASCH & BIRCH, PO BOX 747, FALLS CHURCH, VA, 22040-0747, US

(73) Assignee: Goodrich Hella Aerospace Lighting Systems GmbH, Lippstadt (DE)

(21) Appl. No.: 11/038,410

(22) Filed: Jan. 21, 2005

(30) Foreign Application Priority Data
Nov. 26, 2004 (EP) 04 028 110.7

(51) Int. Cl. B64D 13/00

(52) U.S. Cl. 454/76

(57) ABSTRACT

The air outlet device (10) for the interior of a vehicle, particularly for being arranged above a seat of a vehicle such as, e.g., an airplane, a bus or the like, is provided with an air outlet element (38) comprising two diametrically opposed air inlet openings (44) and an air outlet opening (45). Further, the air outlet device (10) comprises a slide element (46) comprising slide portions (48) allocated to the air inlet openings (44) for blocking and unblocking them, and an actuating element (30) for moving the slide element (46), which is arranged at the air outlet opening (45) and comprises a collar. The actuating element (30) is supported so as to be pivotable about a longitudinal axis (50) of the collar. When the actuating element (30) is rotated, the slide portions (48) of the slide element (46) are movable along a curved path for blocking and unblocking the air outlet openings (45) allocated thereto. The air outlet element (38) comprises a partition (62) shielding the air inlet openings (44) from each other for separating the partial airflows entering through them, and extending to the air outlet opening (45).

The invention relates to an air outlet device for the interior of a vehicle and particularly for being arranged above a seat of a vehicle which is, for example, an airplane, a bus or another means of mass transportation.

In vehicle interiors, diverse air outlet devices are known for the supply of air. Above seats in airplanes or busses, for example, there are adjustable air outlet nozzles pivotably supported in a ball-shaped retaining element. Such an air outlet device, for example, is described in U.S. Pat. No. 5,399,119. In this known air outlet, a closing element is axially displaced when an actuating element is rotated so that an annular air outlet opening is changeable in its cross section.

Another known air outlet device comprises an air outlet duct in which a pivotable flap is rotatably supported in the way of a throttle. By rotation of a collar-shaped actuating element arranged at the air outlet opening and via which the flap can be pivoted, the intensity of the airflow can be influenced. When the flap is inclined, an undesired airflow deflection is produced.

Both afore-mentioned structures have in common that the air outlet duct is considerably limited in its total cross section by the built-in closing elements even if the air outlet device is completely opened. In order to supply a required minimum air quantity in the completely opened condition, it is therefore required to enlarge the actual air outlet duct or the actual air outlet opening. In part, this is aesthetically less appealing and requires more installation room both of which is not desired.

From DE-B-1 218 892, another design of an air outlet device is known which comprises an axially displaceable air outlet fitting. This air outlet fitting cooperates with radial air inlet openings and operates in the way of a slide blocking or unblocking different air inlet openings by moving axially whereby air can be let out either through the outlet fitting only or outside of the outlet fitting or both through the outlet fitting and outside of the outlet fitting.

It is an object of the invention to provide an air outlet device that is able to output a sufficient quantity of air although the air outlet opening cross section is as small as possible. Further, the structure of this air outlet device shall have a simple construction. Finally, the design has to be chosen such that the generation of disturbing flow noise is prevented.

In order to solve this object, the invention suggests an air outlet device for the interior of a vehicle, particularly for being arranged above a seat of a vehicle such as, e.g., an airplane, a bus or the like, the air outlet device being provided with
an air outlet element comprising diametrically opposed air inlet openings and one air outlet opening,
a slide element comprising slide portions allocated to the air inlet openings for blocking and unblocking them, and
an actuating element for moving the slide element, which is arranged at the air outlet opening and comprises a collar, wherein
the actuating element is supported so as to be rotatable about a longitudinal axis of the collar,
the slide portions of the slide element being movable along a curved path for blocking and unblocking the air inlet openings allocated thereto when the actuating element is rotated, and
the air outlet element comprising a partition shielding the air inlet openings from each other for separating partial airflows entering through them, and extending to the air outlet opening.

The air outlet device according to the invention comprises an air outlet element comprising two diametrically opposed air inlet openings for the supply of air and an air outlet opening for the discharge of the supplied air. In this air outlet element, a rotatable slide element is located which is supported so as to be rotatable about the longitudinal axis of the air outlet element and comprises two slide portion serving to block and unblock the two air inlet openings. At the air outlet opening of the air outlet element, an actuating element is arranged which is configured in the way of a collar and is particularly provided with recessed grips or the like features making the handling easier. By rotating the collar-shaped actuating element, the slide element can be turned. In doing so, each of the slide portions of the slide element moves along a curved path.

Apart from the two air inlet openings and the air outlet opening, the air outlet element does not comprise any openings serving the entrance of air to be supplied to the interior. Preferably, the air outlet element is a rotationally symmetric body preferably comprising a cylindrical or a conical or tapered shell wall. The two diametrically opposed air inlet openings are formed in the shell wall. In a first rotational position of the actuating element, the slide portions of the slide element block the two air inlet openings, whereas the slide portions of the slide element substantially unblock these air inlet openings completely in a second rotational position. The slide portions of the slide element and the wall of the air outlet element are arranged so as to be parallel to each other at at least one side of the air inlet opening. This wall portion of the air outlet element and the slide portions, respectively, are configured as parts of rotationally symmetric walls (e.g., cylindrical wall or conical wall).

A preferred embodiment of the invention is to be seen in the configuration of the air outlet element as a conical element with two diametrically arranged air inlet openings extending over the height of the conical wall. The advantage of this arrangement consists in that now, air of an airflow axially impinging onto the tapered end of the truncated air outlet element, substantially without any deflection of the airflow, reaches from the outside of the air outlet element to the interior thereof through which it is discharged again via the air outlet opening. This results in extremely good flow conditions suppressing ambient noise. By the arrangement of the two air inlet openings, favorable opening cross sections can be realized. It is possible, for example, that the total area of all the air inlet openings configured in this way amounts to more than 1 ½ times the cross-sectional area of the air inlet opening. Thus, only the dimensioning of the air outlet opening is decisive for the maximally possible air throughput. Hence, structural elements impairing this maximally possible air throughput are no longer present in the inventive air outlet device in the air supply duct in the region of the air outlet element. The blocking element, namely the slide element, is covered by a part of the air outlet element when the air inlet opening is completely opened, i.e., it does not impair the airflow.

Furthermore, the partition provided according to the invention has a noise-reducing effect on the airflow. This partition extends in transverse direction between the two air outlet openings within the air outlet element; in other words, the partition divides the interior of the air outlet element into two half rooms, an airflow being able to flow into each of these half rooms via the air inlet opening allocated thereto. Substantially, the partition extends to the air outlet opening and divides it into two partial openings each of which is allocated to a different one of the two half rooms.

By configuring the partition, it is avoided that the two partial airflows flowing in via the air inlet opening impinge upon each other but are rather directed parallel to each other. In other words, these two partial airflows emerge from the air outlet opening in a quasi-parallel manner. On the whole, a silent design is thus provided.

For further homogenizing the partial airflows, it is advantageous if at least one cylindrical annular element is held at the partition which substantially extends along the diameter of this annular element. Suitably, that edge of the annular element facing the air inlet openings has a tapering or pointed configuration which has an advantageous effect in terms of flow inasmuch as the turbulences are minimized when the airflow impinges on the annular element. It is suitable to provide two of these annular elements which are arranged concentrically. When the air outlet element is configured as a hollow cone element, the annular elements are arranged at different distances from the air outlet opening and concentric to each other. Because of the annular elements, partial flows directed to the partition as well as to the wall of the air outlet element are produced between the annular elements (only if there are several annular elements). All this has a flow-technical and particularly a noise-reducing effect.

Apart from the fluidically favorable properties (no flow deflection and no baffle elements because of the slide element in the opened condition of the air inlet opening or air inlet openings), the substantially two-piece structure of the air outlet device is extremely simple and clear and thus easy to mount and to maintain and reliable as to its function.

The air outlet device according to the invention can either be arranged rigidly or pivotably (via a ball-headed link).

Hereinafter, the invention is explained in detail with reference to the drawing with respect to an embodiment. In the Figures:

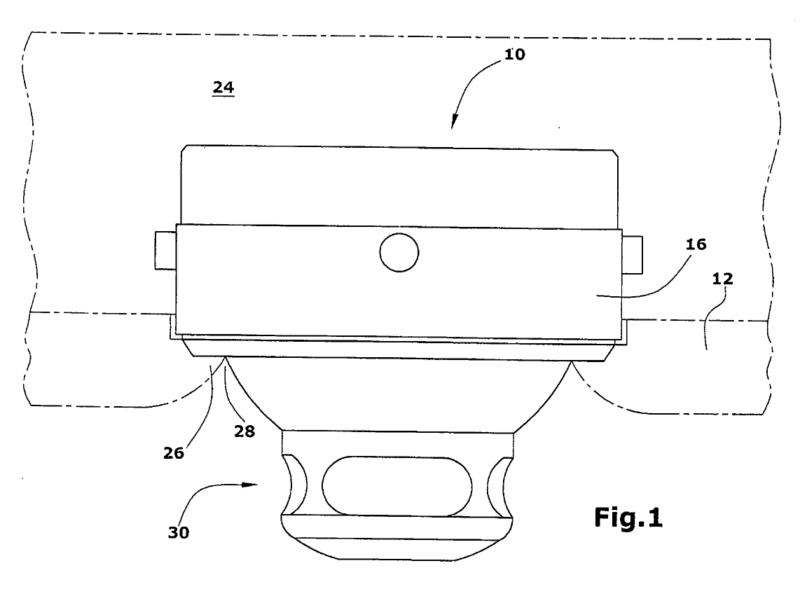

FIG. 1 shows a side view of the air outlet device for aerating a seat in a vehicle such as, e.g., an airplane or a bus, with a hint of a ceiling panel,

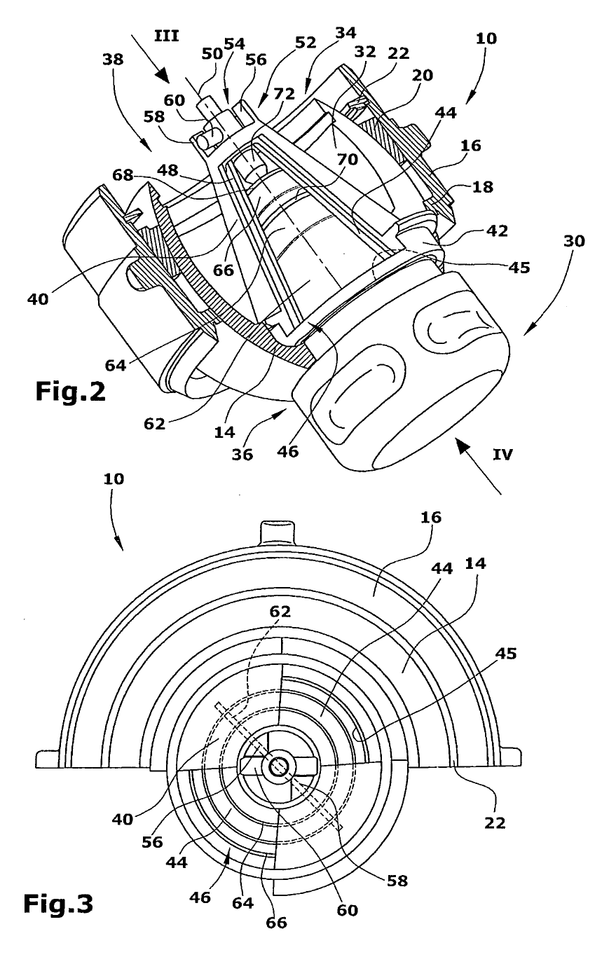

FIG. 2 shows a perspective and partially broken-up representation of the air outlet device to clarify its insides,

FIG. 3 shows a view of the air outlet device in airflow direction, and

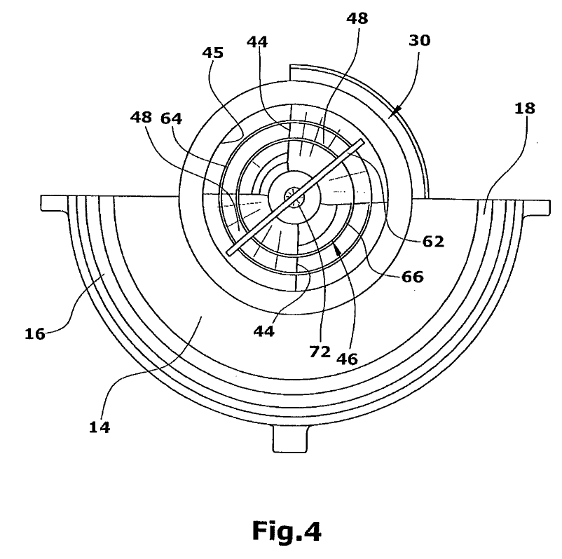

FIG. 4 shows a view of the air outlet device opposite to the flow direction.

In FIGS. 1 to 4, the structure of an air outlet device 10 as well as the cooperation of the individual components of this air outlet device 10 is illustrated. According to FIG. 1, the air outlet device 10 is arranged in the ceiling panelling 12 above a passenger's seat in an airplane or bus, for example. By manually actuating the air outlet device 10, the intensity and direction of an airflow can be changed.

The air outlet device 10 comprises a ball-shaped retaining element 14 being pivotably supported in a cylindrical receiving element 16 within a solid angle range being structurally conditioned with respect to its size. This receiving element 16 is constituted in the way of a sleeve and comprises an inner flange 18 (see FIG. 2) at its end supported on the ceiling paneling 12, said inner flange abutting on the spherical outside of the ball-shaped retaining element 14. At the inside of the receiving element 16, a bearing element (see FIG. 2) is arranged thereat, its outside abutting on the receiving element 16 being cylindrical and its side abutting on the retaining element 14 having a spherically concave configuration. This bearing element 20 does not only serve to bear the ball-shaped retaining element 14 but also to seal the gap between the receiving element 16 and the retaining element 14 airtight. In its built-in position, the bearing element 20 is biased, according to FIG. 2, by a (non-illustrated) corrugated spring washer that is supported on the bearing element 20, on the one hand, and on a circlip ring 22 secured at the receiving element 16, on the other hand.

As shown in FIG. 1, the bearing element 20 is located in a chamber or a channel 24 supplied with pressurized air and at its end provided with the inner flange 18, it sealingly abuts on the edge 26 of an opening 28 of the ceiling paneling 12. Thus, a part of the ball-shaped retaining element 14 as well as an actuating element 30 for setting the intensity and direction of the airflow project from the opening 28.

According to FIG. 2, the retaining element 14 comprises a cylindrical passage 32 the one end 34 of which projects into the channel 24 and at the other end 36 of which the actuating element 30 is arranged. In the interior of the passage 32, there is an air outlet element 38 comprising substantially a conical wall 40 with a cylindrical collar 42. The cylindrical collar 42 is located at the end 36 of the retaining element 14 at which the actuating element 30 is located as well. Thus, the air outlet element 38 projects into the passage 32 conically and opposite to the flow direction.

The conical wall 40 of the air outlet element 38 is provided with two trapezoidal air inlet openings 44 arranged diametrically opposite each other. Substantially, the surface area of each air inlet opening 44 amounts to at least a quarter of the entire conical wall 40. The base of the conical shape of the air outlet element 38 forms an air outlet opening 45.

In the interior of the air outlet element 38, a slide element 46 is arranged which comprises two slide portions 48 which, when the slide element 46 also being substantially conical is rotated, can be brought in superposition with the air inlet openings 44. Preferably, the slide element 46 is integrally formed with the collar-shaped actuating element 30, i.e., it can be turned about the longitudinal axis 50 of the air outlet element 38 in the latter.

By the conical or truncated configuration of both the air outlet element 38 and the slide element 46, it is reliably achieved that the slide portions 48 seal the air inlet openings 44 tight in a reliable manner, taking process tolerances to be provided into consideration. Due to the fact that the two conical elements are axially brought together, the slide portions 48 always abut two-dimensionally and thus air-tight on the remaining portions of the conical wall 40 of the air outlet element 38.

At their tapered ends 52 and 54, respectively, the two elements (air outlet element 38 and slide element 46) can be connected with each other. In this region, the maximally tolerable rotational range of the actuating element 30 for completely opening the air inlet openings 44 and for completely closing the air inlet openings 44 can also be set by providing stop elements 56,58 at the air outlet element 38 and a corresponding stop element 60 at the slide element 46.

To clarify the inner structure of the air outlet device 10 described above with reference to FIG. 2, FIGS. 3 and 4 show further views of the air outlet device 10.

As shown in the Figures (refer to FIGS. 2 to 4 in particular), a partition 62 shielding the two air inlet openings 44 from each other is inserted in the air outlet element 38. In the illustration according to FIG. 4, the partition 62 forms the axis of symmetry for the air inlet openings 44 arranged so as to be diametrically opposed. Two cylindrical annular elements 64,66 are held by the partition 62 which extends substantially along the diameters of these cylindrical annular elements 64,66. The annular elements 64,66 are arranged at different distances from the air outlet opening 45.

In FIGS. 2 to 4, the partition 62 is shown as being held at the slide portions 48 of the slide element 46. The slide element 46, however, may also be arranged outside the conical wall 40 of the air outlet element 38 so that, this being the case, the partition 62 is adjacent to the conical wall 40 inside. This last-mentioned variant is preferred inasmuch as the partition 62 is always located between the air inlet openings 44 of the air outlet element 38 in the same manner in any opening position of the slide element 46.

The partition 62 serves to guide and divide the air flowing in via the air inlet openings 44. The partition 62 projects into the outlet opening 45. At their edges 68,70 facing away from the air outlet opening 45, the annular elements 64,66 have a tapered configuration. At its end facing away from the air outlet opening 45, the partition 62 may comprise a stud or thickening 72 projecting beyond the opposed sides of the partition 62, which, at the same time, serves to support the partition 62 at the slide element 46 or at the face of the conical wall 40 of the air outlet element 38.

1. Air outlet device for the interior of a vehicle, particularly for being arranged above a seat of a vehicle such as, e.g., an airplane, a bus or the like, comprising
an air outlet element (38) comprising two diametrically opposed air inlet openings (44) and one air outlet opening (45),
a slide element (46) comprising slide portions (48) allocated to the air inlet openings (44) for blocking and unblocking them, and
an actuating element (30) for moving the slide element (46), which is arranged at the air outlet opening (45) and comprises a collar, wherein
the actuating element (30) is supported so as to be rotatable about a longitudinal axis (50) of the collar,
the slide portions (48) of the slide element (46) being movable along a curved path for blocking and unblocking the air inlet openings (45) allocated thereto when the actuating element (30) is rotated, and
the air outlet element (38) comprising a partition (62) shielding the air inlet openings (44) from each other for separating partial airflows entering through them, and extending to the air outlet opening (45).

2. Air outlet device according to claim 1, characterized in that at the partition (62), at least one cylindrical annular element (64,66) is held along the diameter of which the partition (62) extends.

3. Air outlet device according to claim 2, characterized in that at the partition (62), at least two annular elements (64,66) are held which have different distances from the air outlet opening (45) of the air outlet element (38).

4. Air outlet device according to claim 2 or 3, characterized in that each annular element (64,66) comprises a tapering edge (68,70) facing away from the air outlet opening (45) of the air outlet element (38).

5. Air outlet device according to claim 1, characterized in that the air outlet element (38) is rotationally symmetric and comprises a shell (40), and that the two air inlet openings (44) are formed in the shell (40).

6. Air outlet device according to claim 5, characterized in that the shell (40) is a cylindrical wall.

7. Air outlet device according to claim 6, characterized in that the shell (40) is conical.

8. Air outlet device according to claim 1, characterized in that the slide element (46) and the air outlet element (38) are substantially configured in a uniform manner.

9. Air outlet device according to claim 8, characterized in that each of the slide element (46) and the air outlet element (38) comprises two diametrically opposed openings (44) extending over about 90□ in circumferential direction and/or over substantially the entire axial length of the shell (40).

10. Air outlet device according to claim 1, characterized in that the slide element (46) is supported at the outside of the air outlet element (38).

11. Air outlet device according to claim 1, characterized in that the air outlet element (38) is retained by a retaining element (14) forming a part of an air outlet duct and comprising a spherical outer surface and being pivotably supported in a receiving element (16).
